(19) United States
(12) Patent Application Publication
(10) Pub. No.: US 2005/0138820 A1
(43) Pub. Date: Jun. 30, 2005

(54) Saw handle grip

(76) Inventors: Leslie Daily Gist, Huntersville, NC (US); Eric Helda, Huntersville, NC (US); Steven R. Levine, Mooresville, NC (US); Gregory C. Schultz, Huntersville, NC (US)

Correspondence Address: BRINKS HOFER GILSON & LIONE, P.O. BOX 10395, CHICAGO, IL, 60610, US

(21) Appl. No.: 11/004,008

(22) Filed: Dec. 3, 2004

Related U.S. Application Data
(60) Provisional application No. 60/527,269, filed on Dec. 5, 2003.

(51) Int. Cl. B25G 1/00

(52) U.S. Cl. 30/517; 30/340; 30/342

(57) ABSTRACT

A saw handle grip cover includes a molded shell configured to conform to an outer body shape of a saw handle. The molded shell is constructed of relatively stiff material. An outer layer, secured thereto to the molded shell, is constructed of a softer material than said molded shell. The molded shell covers at least a grippable portion of the saw handle, and the outer layer is delimited by a circumferential outer edge of the molded shell

This application claims the benefit of U.S. Provisional Application No. 60/527,269 filed Dec. 5, 2003, the entire contents of which are incorporated herein by reference.

### BACKGROUND

This invention relates, in general, to a gripping end of a saw handle or any other tool that incorporates the use of a hand to operate the tool. In particular, the present invention relates to a molded saw handle grip, with a soft cover thereon, which would be attached onto the gripping end of the saw handle.

Tool users typically require tools that are durable and will withstand significant daily use over long periods of time. Preferably, such tools are also comfortable in the hands of the users and provide the users with a good grip. Often, many users prefer the warmth, durability and feel of a natural wood handle when using a hand saw, for example. However, the comfort of a wooden handle sometimes is offset by the roughness of its edges, and its slipperiness. Accordingly, the present invention improves upon the prior art by providing a tool handle grip, such as for a saw, which has a softer cover physically attached to a hard, ornamental wood handle.

Such handle grips should not add any substantial amount of weight to the handle of the corresponding tools; as such the added grip weight is kept at an acceptable level that does not introduce any substantial weight related fatigue during a lengthy use of the tool. For this reason, the weight of both the hard and soft portions of such handle grips is kept as light as possible while still preventing any material breakdown due to pressure exerted by the user during use.

Such handle grips should not increase a grip area, i.e. grip size, substantially, as any wider grip would be impractical for obvious reasons, such as inefficient gripping. Hence, such handle grips must be designed to comfortably fit the grip of the user and provide a simple structure to attach to a handle. The handle grip is typically a complex geometric structure molded to fit the corresponding geometric outer surface of the tool handle. Molding problems are negligible as typically outer surfaces can be molded by most modern molding techniques.

In view of the above discussed handle grip characteristics, it is advantageous to provide a tool handle grip which can be molded to any desired shape to match the receiving tool handle, be easily attached to the tool handle, is comfortable and durable.

### BRIEF SUMMARY

A saw handle grip cover comprises a molded shell configured to conform to an outer body shape of a saw handle, such as a wooden saw handle. The molded shell is constructed of a relatively stiff material. An outer layer, secured thereto to the molded shell, is constructed of a soft material. The molded shell covers at least a grippable portion of the saw handle, and the outer layer is delimited by a circumferential outer edge of the molded shell.

Further aspects and advantages of the invention are described below in conjunction with the present embodiments.

### BRIEF DESCRIPTION OF THE DRAWINGS

The invention, together with the advantages thereof, may be understood by reference to the following description in conjunction with the accompanying figures, which illustrate some embodiments of the invention.

FIG. 1 is an exploded view of a saw handle grip cover embodiment in accordance with the present invention;

FIG. 2 is an exploded view of another handle grip cover embodiment in accordance with the present invention;

FIG. 3a-3b is an exploded view of still another handle grip cover embodiment in accordance with the present invention;

FIGS. 4a-4d represent five additional alternate embodiments of a saw handle grip in accordance with the present invention; and

FIGS. 5a-5c represent three embodiments of a jab saw handle in accordance with the present invention.

### DETAILED DESCRIPTION OF THE DRAWINGS

While the present invention is susceptible of embodiment in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” object is intended to denote also one of a possible plurality of such objects.

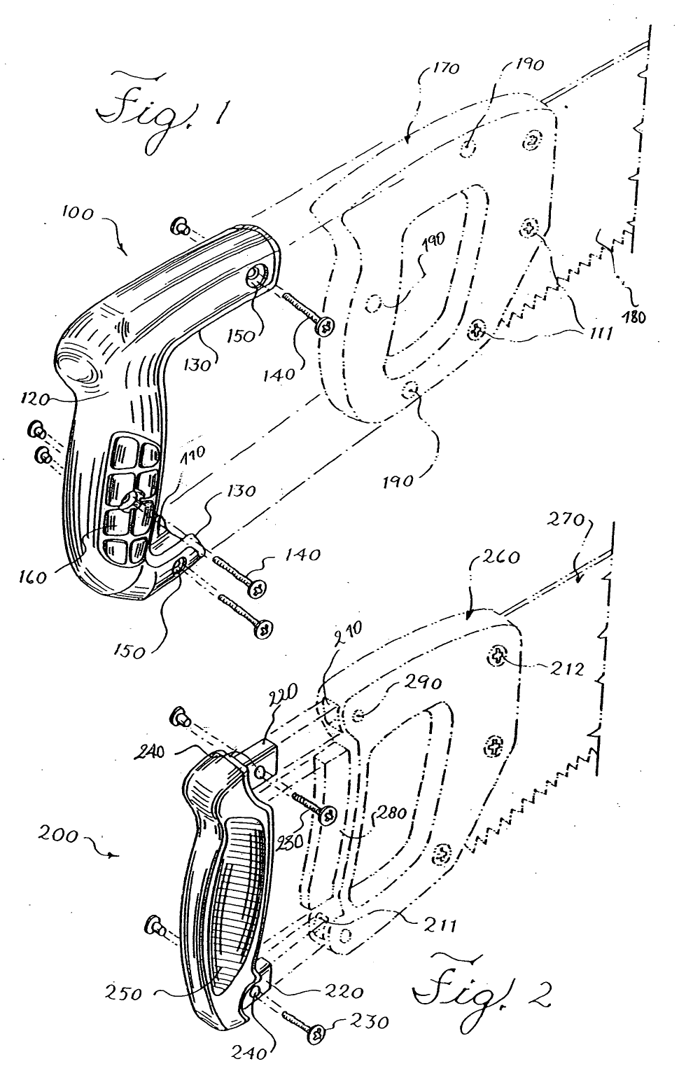

With reference to the drawings and initially to FIG. 1, a saw handle grip labeled 100 is shown in solid lines. The saw handle grip 100 is shown in an exploded view separated from a conventional wooden hand saw handle 170, illustrated in broken lines. The saw handle grip 100 sleeves the top, bottom and sides of a saw handle 170, to conform to part or most of the outer surface of the saw handle 170. Thus, the saw handle grip 100 includes an internal channel that surrounds a portion of the outer surface of the saw handle 170. The saw handle grip 100 is constructed with an inner shell 110, and a softer cover overlay 120 which provides a comfortable contact surface to the user. The softer cover overlay 120 is physically attached to the inner shell 110 via glue or any other biding material.

The inner shell 110 can be constructed out of any hard synthetic used commonly nowadays for other grips, such as a polymer. The softer overlay 120 can be constructed of an elastomer to provide a softer grip to the user. This combination of hard inner shell 110 and softer overlay cover 120 can offer the most natural and comfortable grip one may obtain on a saw handle or other hand tool.

The saw handle grip 100 can be attached to the saw handle 170 via screws 140, in three secure positions 190, independently of blade screws 111 that attach the saw handle 170 to the saw blade 180. Alternatively, the handle grip 100 may be molded in a manner wherein these secure positions 190 may coincide with the blade screw locations 111 or a typical wooden saw handle. Hence, a simple arrangement permits an attachment of the molded handle grip 100 to the saw handle 170. The attachment is rendered simple because the inner shell 110 is typically molded to present a conforming sleeve to the corresponding outer geometry of the saw handle 170 portion covered by the inner shell 110.

The outer surface of the soft cover 120 can be shaped in any desirable geometry that conforms to the inner shell molded structure. That is, the outer surface of the shell generally covers the entire inner shell 110 except in certain predetermined regions that are raised by a molding process. These regions include a circumferential outer edge 130 of the inner shell 11 that determines the outer perimeter or contour of the saw handle grip 110. The outer edge 130 being made of the same hard synthetic material as the inner shell 110 allows for the preservation of the original contour of the saw handle grip 100. The hardness of the outer edge 130 serves to prevent any breakdown, erosion or abrasion of the circumferential shape of the handle grip 100 by withstanding significant uses over long periods of time. The hardness of the outer edge 130 may also act as a bumper to protect the underlying wood handle.

In the present embodiment the materials used for the inner shell 110 and the outer layer cover 120 are of substantially different color so as to provide a contrast between them. Further, the outer layer cover 120 may include a design and or a writing which may stand out relatively to the rest of the outer layer cover 120.

The saw handle grip 100 may be shaped to present corners, angles or curves, not necessarily original to the underlying wooden saw handle, for enhancing the control and grip of the saw handle, and also part of the outer surface of the grip may be have a dimpled or a roughened surface for further enhancement of the grip of the saw handle. That is, the cross-sectional configuration of the combination of the inner shell 110 and outer overlay cover 120 can enhance the feel and grip on the handle, and such enhancement may also be in conjunction with having the surface of the outer layer of the overlay cover 120 marked of a dimpled or pockmarked arrangement so that it is irregular to further enhance security of the user's hand grip thereon.

In the present embodiment the difference between the inner shell 110 and the outer layer cover 120 has been described as being with respect to color, as well as of relative hardness or the like to improve grip and reduce abrasion in certain areas of the saw handle grip 100. Further, the combination of the inner shell 110 and outer overlay soft cover 120 corresponding materials allow this invention to withstand repeated cleaning without noticeable deterioration.

The saw handle grip 100 can be attached to the saw handle 170 via screws 140, or fastened via other acceptable devices. The fastening locations of the screws 140 on the saw handle grip 100 each form a hollow cavity 150 that is shaped to receive a fastener, such as a screw or a rivet 140, without allowing the fastener to protrude above the outer surface of the outer layer cover. As such, the saw handle grip 100 can be secured to an underneath solid or hollow core piece of a saw handle 170.

To limit further repetitions of the above discussion, all subsequently discussed saw handle grips may include an inner shell constructed out of any hard synthetic used commonly nowadays for other grips, such as a polymer, and a softer overlay constructed of an elastomer to provide a softer grip to the user. The softer overlay covers can be physically attached to the inner shells via glue or any other biding material. Further, circumferential outer edges of the saw handle grips may determine the outer perimeter or contour of the saw handle grips. In addition, the materials used for the inner shells and the outer layer covers may be of substantially different color so as to provide a contrast between them, and the outer layer covers may include a design and or a writing which may stand out relatively to the rest of the respective outer layer covers. Also, while in the previous embodiment, the saw handle grip 100 acted to overlay a wooden saw handle 170, it is not necessary for a wooden handle to be present in other embodiments, i.e. may be a plastic handle, etc. . . .

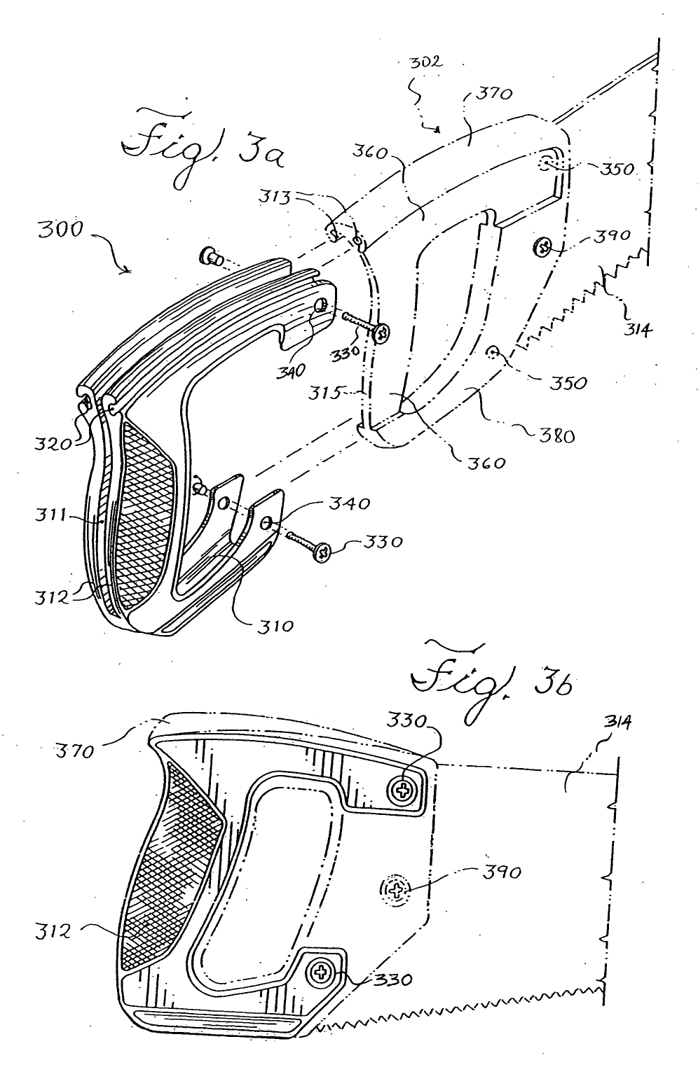

Referring to FIG. 2, another embodiment of a saw handle grip labeled 200 is shown in solid lines. The saw handle grip 200 is shown distanced from a saw handle 260, illustrated in broken lines. The saw handle grip 200 is molded to present a pair of bolt tabs 220 and a saw handle grip cavity (not shown) at the front end of the handle grip 200. The bolt tabs 220 can be made of the same material as that of the inner shell. The cavity is positioned between the pair of tabs 220. The pair of bolt tabs 220 include each a hollow cavity 240 that is shaped to receive a fastener 230, such as a screw, a rivet, or a bolt 230.

The saw handle 260, which may be wooden or metal, provides holes 210 for receiving bolt tabs 220. Further, the saw handle 260 includes a projection 280 designed to communicate with the saw handle grip cavity (not shown). The saw handle grip 200 can be fastened to the saw handle 260 via bolts 230. The fastening locations 240 of the saw handle grip 200 correspond to the saw handle holes 290 designed to receive bolts 230. As such, the saw handle grip 200 can be secured to the saw handle 260 independently of blade fasteners 212 used for attaching blade 270.

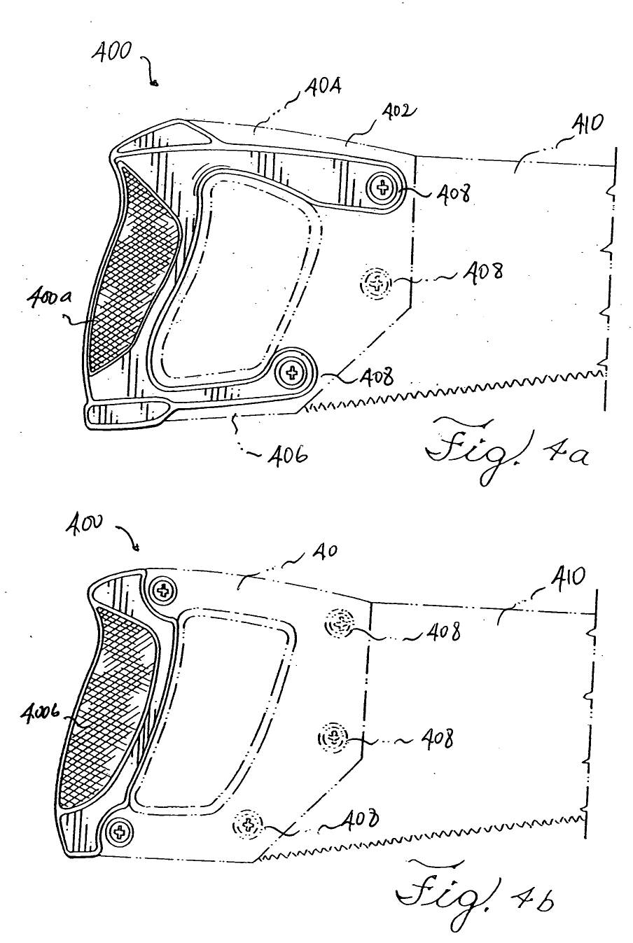

Referring to FIG. 3a, another embodiment of a saw handle grip labeled 300 is shown in solid lines. The saw handle grip 300 is shown distanced from a skeletal-like framed saw handle 302, illustrated in broken lines. The saw handle grip 300 is molded to wrap around a saw handle bottom 380, sleeve around the sides of the middle portion 360 of the saw handle 302, and slide into T-grooves 313 along the top 370 of the saw handle 302. A pair of sleeves 312 each presents a rail 320 at its respective top ends, wherein the pair of rails 320 slide into the matching T-grooves 313 located on the top of the saw handle 370.

The saw handle grip 300 presents a channel 310 to wrap only around the bottom portion 380 of the saw handle 370. The sleeves 312 extend vertically from a location near the channel 310 to another location below the pair of rails 320. As such the pair of sleeves 312 defines an opening 311 designed to communicate with a thinner middle portion 360 of the saw handle 302. The thinner middle portion 360 extends vertically from between the T-grooves 313 to the bottom portion 380 of the saw handle 302. Adjacently to the T grooves 313, the thinner middle portion 360 extends forward along most of the length of the T-grooves 313 to include a fastening location 350. As such, the back end surface 315 of the saw handle 302 is sandwiched between the back ends of the pair of sleeves 312, and is configured to extend to the back end of the narrower channel 311. For fastening purposes, the saw handle grip 300 and the saw handle 302 provide corresponding cavities 340 and 350, respectively. Hence, the saw handle grip 300 can be fastened to the saw handle 302 via fasteners 330. Also as shown, fasteners 330 combine with fastener 390 to attach a blade 314 to the saw handle 302 in three secure positions. FIG. 3b illustrates a resulting configuration when the saw handle grip 300 is attached to the saw handle 302.

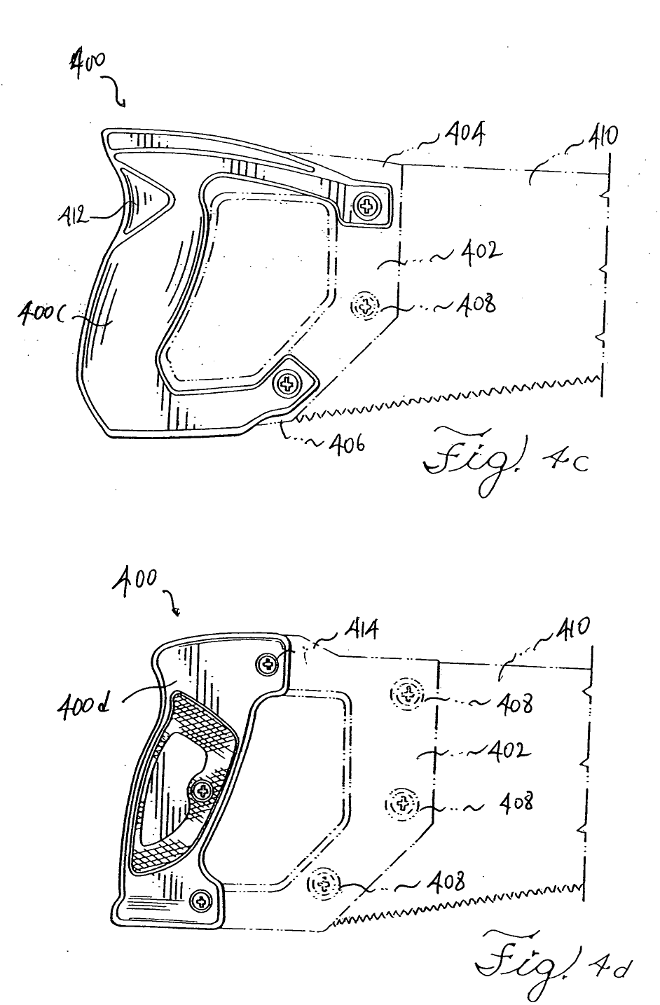

Referring to FIGS. 4a-4d, four alternate embodiments of a saw handle grip are illustrated. These four alternate embodiments may be constructed of any combination of the above discussed alternate saw handle grips, namely 100, 200, and 300. Using FIGS. 3a-3b as examples, FIG. 4a illustrates a saw handle grip 400a that sleeves the top 404 and bottom 406 of a saw handle 402, and is secured to the saw handle 402 at the extreme two of three positions 408 used for attaching a blade 410 to the saw handle 402. Further the saw handle grip 400a provides for a slightly wider hand opening to accommodate gloved hands.

FIG. 4b illustrates a saw handle grip 400b that may be sleeved over or inserted into a wooden portion of a saw handle 402 with bolt tabs (not shown) independent of blade screws 408, which attach a blade 410 in 3 secure positions. The bolt tabs are configured to communicate with holes of the saw handle 402. FIG. 4c illustrates a saw handle grip 400c that sleeves the top 404 and bottom 406 of a saw handle 402, and is secured to the saw handle 402 at the extreme two of three positions 408 used for attaching a blade 410 to the saw handle 402. Further, an inset area 412 in the saw handle 402 is provided for the web of the user hand to rest in. FIG. 4d illustrates a saw handle grip 400d that wraps fully around the handle portion of a saw handle 402, and attaches to the saw handle 402 at three locations 414 independent of the locations 408 used for fastening a blade 410 to the saw handle 402. Further, the saw handle grip 400d provides for a slightly larger hand opening to accommodate gloved hands.

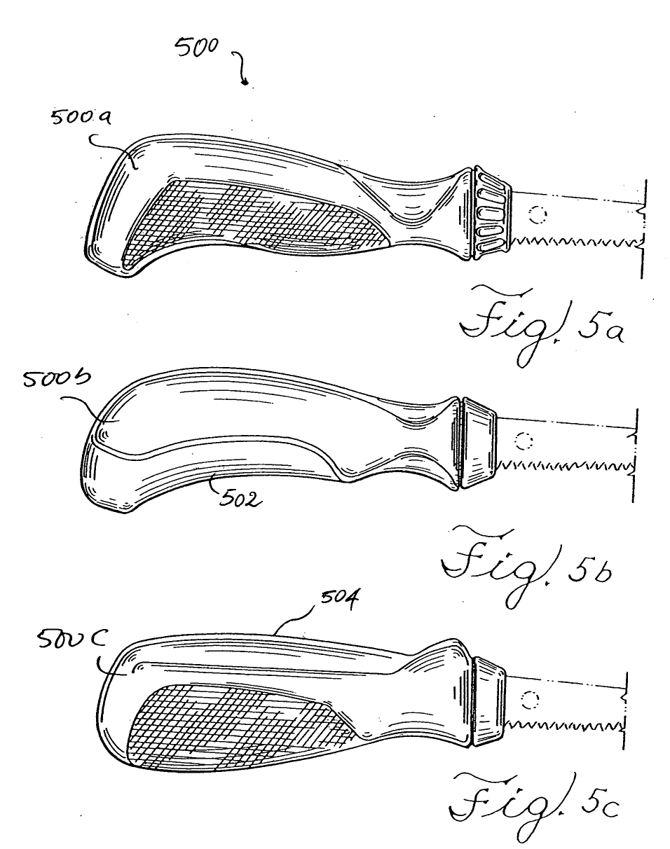

Now referring to FIGS. 5a-5c, three embodiments of a drywall jab saw handle grip are illustrated. These three jab saw embodiments may be constructed of any combination of the above discussed alternate saw handle grips, namely 100, 200, and 300. FIG. 5a illustrates a jab saw handle grip 500a that introduces a typically traditional design having a larger back end for palming and a thinner neck for precision work. In this embodiment, the jab saw handle grip 500a completely surrounds and engagingly encloses the jab saw handle core (not shown). The jab saw handle grip 500a is attached to the jab saw handle core via glue or other binding material. The jab saw handle core may be wooden or plastic.

FIG. 5b illustrates a jab saw handle 500b with a similar traditional design to the one introduced in FIG. 5a. However as shown, in this embodiment, the jab saw handle grip 500b does not completely enclose the saw handle core 502, and portions of the bottom and back ends of the jab saw handle core 502 are visible. The jab saw handle grip 500b is attached to the jab saw handle core 502 via glue or other binding material. FIG. 5c illustrates a jab saw handle grip 500c with a symmetrical design to allow for multiple hand positions, and a flat top 504 to provide for better gripping when rotating the jab saw handle grip 500c in the user's hand. In this embodiment, the jab saw handle grip 500c completely surrounds and engagingly encloses the jab saw handle core (not shown). The jab saw handle grip 500b is attached to the jab saw handle core (not shown) via glue or other binding material.

Specific embodiments of a saw handle grip, according to the present invention, have been described for the purpose of illustrating the manner in which the invention is used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

1. A saw handle grip for covering a saw handle comprising:
a molded shell configured to conform to an outer body shape of a saw handle; and
an outer layer secured to said molded shell,
wherein said outer layer is constructed of a material that is softer than that of said molded shell, said molded shell covers at least a grippable portion of said saw handle, and said outer layer is delimited by a circumferential outer edge of said molded shell.

2. The saw handle grip as in claim 1, wherein said molded shell material is a polymer.

3. The saw handle grip as in claim 1, wherein said softer material of said outer layer is an elastomer.

4. The saw handle grip as in claim 1, wherein said outer layer is physically attached to said molded shell via glue or other binding material.

5. The saw handle grip as in claim 1, wherein said circumferential outer edge of said molded shell is made of a same material as that of said molded shell.

6. The saw handle grip as in claim 1, wherein a surface transition from said outer layer to said circumferential outer edge of said molded shell is uniform.

7. The saw handle grip as in claim 1, wherein said molded shell and said outer layer are of substantially different color to provide a visual contrast between them.

8. The saw handle grip as in claim 1, wherein said molded shell comprises an inner channel that communicates with most or part of a gripping portion of said saw handle.

9. The saw handle grip as in claim 1, wherein said molded shell is shaped to present corners, angles or curves for enhancing a control and a grip of said saw handle.

10. The saw handle grip as in claim 1, wherein said circumferential outer layer includes a design or a writing that stands out relatively to a remaining portion of said outer layer.

11. The saw handle grip as in claim 10, wherein said design is dimpled, pockmarked, or raised to render said saw handle grip irregular.

12. A saw handle grip comprising:
a molded shell having bolt tabs located at a front end and a cavity located between said bolt tabs; and
an outer layer secured to said molded shell,
wherein said outer layer being constructed of a softer material than that of said molded shell, and is delimited by a circumferential outer edge of said molded shell, and
wherein said bolt tabs communicate with holes of a saw handle, and said cavity is configured to receive a tab from said saw handle.

13. The saw handle grip as in claim 12, wherein said molded shell material is a polymer.

14. The saw handle grip as in claim 12, wherein said softer material of said outer layer is an elastomer.

15. The saw handle grip as in claim 12, wherein said soft outer layer is physically attached to said molded shell via glue or other biding material.

16. The saw handle grip as in claim 12, wherein said circumferential outer edge of said molded shell is made of a same material as said molded shell.

17. The saw handle grip as in claim 12 wherein a surface transition from said outer layer to said circumferential outer edge of said molded inner shell is uniform.

18. The saw handle grip as in claim 12, wherein said molded shell and said outer layer are of substantially different color to provide a visual contrast between them.

19. The saw handle grip as in claim 12, wherein said outer layer includes a design or a writing that may stand out relatively to a remaining portion of said outer layer.

20. The saw handle grip as in claim 19, wherein said design is dimpled, pockmarked, or raised to render said saw handle grip irregular.

21. The saw handle grip as in claim 19, wherein said saw handle is Is a core sized to receive said grip.

22. A saw handle grip comprising:
a molded shell having a bottom channel, and a pair of sleeves extending vertically from said bottom channel; and
an outer layer secured to said molded shell,
wherein said outer layer is constructed of a softer material than that of said molded shell, and is delimited by a circumferential outer edge of said molded shell, and
wherein said bottom channel wraps around a bottom end of a saw handle, said pair of sleeves communicate with a middle portion of said saw handle and include each a rail at their respective top, said sleeve rails communicate with a pair of T-grooves located at a top end of said saw handle.

23. The saw handle grip as in claim 22, wherein said molded shell material is a polymer.

24. The saw handle grip as in claim 22 wherein said softer material of said outer layer is an elastomer.

25. The saw handle grip as in claim 22, wherein said outer layer is physically attached to said molded shell via glue or other biding material.

26. The saw handle grip as in claim 22, wherein said circumferential outer edge of said molded shell is made of a same material as that of said molded shell.

27. The saw handle grip as in claim 22, wherein a surface transition from said outer layer to said circumferential outer edge of said molded shell is uniform.

28. The saw handle grip as in claim 22, wherein said molded shell and said outer layer are of substantially different color to provide a visual contrast between them.

29. The saw handle grip as in claim 22, wherein said outer layer includes a design or a writing that stands out relatively to a remaining portion of said outer layer.

30. The saw handle grip as in claim 22, wherein said design is dimpled, pockmarked, or raised to render said saw handle grip irregular.

31. A saw comprising:
a saw blade;
a saw handle attached to said saw blade; and
a saw handle grip for covering said saw handle, said saw handle grip comprising:
a molded shell configured to conform to an outer body shape of a saw handle; and
an outer layer secured to said molded shell,
wherein said outer layer is constructed of a material that is softer than that of said molded shell, said molded shell covers at least a grippable portion of said saw handle, and said outer layer is delimited by a circumferential outer edge of said molded shell.

32. The saw as in claim 31, wherein said molded shell material is a polymer.

33. The saw as in claim 31, wherein said softer material of said outer layer is an elastomer.

34. The saw as in claim 31, wherein said outer layer is physically attached to said molded shell via glue or other binding material.

35. The saw as in claim 31, wherein said circumferential outer edge of said molded shell is made of a same material as that of said molded shell.

36. The saw as in claim 31, wherein a surface transition from said outer layer to said circumferential outer edge of said molded shell is uniform.

37. The saw in claim 31, wherein said molded shell and said outer layer are of substantially different color to provide a visual contrast between them.

38. The saw as in claim 31, wherein said molded shell comprises an inner channel that communicates with most or part of a gripping portion of said saw handle.

39. The saw as in claim 31, wherein said molded shell is shaped to present corners, angles or curves for enhancing a control and a grip of said saw handle.

40. The saw as in claim 1, wherein said circumferential outer layer includes a design or a writing that stands out relatively to a remaining portion of said outer layer.

41. The saw as in claim 40, wherein said design is dimpled, pockmarked, or raised to render said saw handle grip irregular.

42. A saw comprising:
a saw blade;
a saw handle attached to said saw blade; and
a saw handle grip for covering said saw handle, said saw handle grip comprising:
a molded shell having bolt tabs located at a front end and a cavity located between said bolt tabs; and
an outer layer secured to said molded shell,
wherein said outer layer being constructed of a softer material than that of said molded shell, and is delimited by a circumferential outer edge of said molded shell, and
wherein said bolt tabs communicate with holes of a saw handle, and said cavity is configured to receive a tab from said saw handle.

43. The saw as in claim 42, wherein said molded shell material is a polymer.

44. The saw as in claim 42, wherein said softer material of said outer layer is an elastomer.

45. The saw as in claim 42, wherein said soft outer layer is physically attached to said molded shell via glue or other biding material.

46. The saw as in claim 42, wherein said circumferential outer edge of said molded shell is made of a same material as said molded shell.

47. The saw as in claim 42 wherein a surface transition from said outer layer to said circumferential outer edge of said molded inner shell is uniform.

48. The saw as in claim 42, wherein said molded shell and said outer layer are of substantially different color to provide a visual contrast between them.

49. The saw as in claim 42, wherein said outer layer includes a design or a writing that may stand out relatively to a remaining portion of said outer layer.

50. The saw handle grip as in claim 49, wherein said design is dimpled, pockmarked, or raised to render said saw handle grip irregular.

51. The saw handle grip as in claim 49, wherein said saw handle is Is a core sized to receive said grip.

52. A saw comprising:
a saw blade;
a saw handle attached to said saw blade; and
a saw handle grip for covering said saw handle, said saw handle grip comprising:
a molded shell having a bottom channel, and a pair of sleeves extending vertically from said bottom channel; and
an outer layer secured to said molded shell,
wherein said outer layer is constructed of a softer material than that of said molded shell, and is delimited by a circumferential outer edge of said molded shell, and
wherein said bottom channel wraps around a bottom end of a saw handle, said pair of sleeves communicate with a middle portion of said saw handle and include each a rail at their respective top, said sleeve rails communicate with a pair of T-grooves located at a top end of said saw handle.

53. The saw as in claim 52, wherein said molded shell material is a polymer.

54. The saw as in claim 52 wherein said softer material of said outer layer is an elastomer.

55. The saw as in claim 52, wherein said outer layer is physically attached to said molded shell via glue or other biding material.

56. The saw as in claim 52, wherein said circumferential outer edge of said molded shell is made of a same material as that of said molded shell.

57. The saw as in claim 52, wherein a surface transition from said outer layer to said circumferential outer edge of said molded shell is uniform.

58. The saw as in claim 52, wherein said molded shell and said outer layer are of substantially different color to provide a visual contrast between them.

59. The saw as in claim 52, wherein said outer layer includes a design or a writing that stands out relatively to a remaining portion of said outer layer.

60. The saw as in claim 52, wherein said design is dimpled, pockmarked, or raised to render said saw handle grip irregular.
